(19) United States
(12) Patent Application Publication
(10) Pub. No.: US 2024/0010190 A1
(43) Pub. Date: Jan. 11, 2024

(54) SYSTEMS AND METHODS FOR POTHOLE DETECTION AND AVOIDANCE

(71) Applicant: Honda Motor Co., Ltd., Tokyo (JP)

(72) Inventors: Tyler Naes, Farmington, MI (US); Laith Daman, Novi, MI (US); Amer Abughaida, Ann Arbor, MI (US); Yasir Al-Nadawi, Ann Arbor, MI (US); Joseph Nieman, Dundee, MI (US); Kathiravan Natarajan, Richardson, TX (US); Shigenobu Saigusa, Saitama (JP)

(21) Appl. No.: 17/862,065

(22) Filed: Jul. 11, 2022

(51) Int. Cl. B60W 30/09; B60W 50/14

(52) U.S. Cl. CPC B60W 30/09; B60W 50/14; B60W 2556/45; B60W 2552/35; B60W 2420/42; B60W 2050/146

(57) ABSTRACT

A system is provided. The system includes a first vehicle controller , a second vehicle controller, and a remote server. The first vehicle controller is programmed to: a) detect an obstacle, b) activate at least one rear-facing sensor to capture a recording of the obstacle; and c) transmit the recording of the obstacle and a location of the first vehicle. The remote server is programmed to a) determine and store a first location of the obstacle, b) subsequent to storing the first location of the obstacle, c) receive a current location of the second vehicle, and d) compare the current location of the second vehicle to the stored first location of the obstacle. The second vehicle controller is programmed to: a) receive the information about the obstacle and b) adjust operation of the second vehicle to avoid the obstacle.

### FIELD OF THE INVENTION

The present disclosure relates to pothole detection and avoidance and, more particularly, to a system and method for detecting potholes and controlling a subsequent vehicle to avoid the detected potholes.

### BACKGROUND

Modern roadways can include many stationary or temporary hazards, such potholes, and debris in the roadway. Potholes not only have a chance of damaging a vehicle driving over the pothole, but also decrease the driver's and passenger's enjoyment of the ride. However, in many cases, potholes might not be detected by the driver and/or the vehicle itself until it is too late to act. Accordingly, it would be desirable to have a system that assists drivers by warning them about upcoming potholes, or other hazards, and assist the driver in navigating around the pothole or other hazard.

### BRIEF SUMMARY

In one aspect, a system is provided. The system includes a first vehicle including a plurality of sensors and a first vehicle controller. The system also includes a remote server including at least one processor and at least one memory device. The system further includes a second vehicle including a second vehicle controller. The first vehicle controller is programmed to receive a plurality of information from the plurality of sensors. The first vehicle controller is also programmed to detect an obstacle based on the plurality of information from the plurality of sensors. The first vehicle controller is further programmed to activate at least one rear-facing sensor of the plurality of sensors to capture a recording of the obstacle. In addition, the first vehicle controller is programmed to transmit the recording of the obstacle and a location of the first vehicle. The remote server is programmed to determine a first location of the obstacle based on the recording of the obstacle and the location of the first vehicle. The remote server is also programmed to store the first location of the obstacle. Subsequent to storing the first location of the obstacle, the remote server is programmed to receive a current location of the second vehicle from the second vehicle controller. The remote server is further programmed to compare the current location of the second vehicle to the stored first location of the obstacle to determine if the second vehicle is approaching the first location. If the second vehicle is approaching the first location, the remote server is programmed to transmit information about the obstacle to the second vehicle controller. The second vehicle controller is programmed to receive the information about the obstacle from the remote server. The second vehicle controller is also programmed to adjust operation of the second vehicle to avoid the obstacle. The system may have additional, less, or alternate functionality, including that discussed elsewhere herein.

In another aspect, a computer device is provided. The computer device includes at least one memory and at least one processor in communication with the at least one memory. The computer device is in communication with a first vehicle controller associated with a first vehicle and further in communication with a second vehicle controller associated with a second vehicle. The at least one processor is programmed to receive a recording and location information of an obstacle from the first vehicle controller. The recording includes at least one of video or a plurality of images of the obstacle in a roadway. The at least one processor is also programmed to determine a first location of the obstacle based on the recording of the obstacle and the location of the first vehicle. The at least one processor is further programmed to store the first location of the obstacle. Subsequent to storing the first location of the obstacle, the at least one processor is programmed to receive a current location of the second vehicle from the second vehicle controller. In addition, the at least one processor is programmed to compare the current location of the second vehicle to the stored first location of the obstacle to determine if the second vehicle is approaching the first location. If the second vehicle is approaching the first location, the at least one processor is programmed to transmit information about the obstacle to the second vehicle controller, wherein the second vehicle controller is programmed to adjust operation of the second vehicle to avoid the obstacle. The computer device may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle, in accordance with one embodiment of the present disclosure.

FIGS. 2A and 2B illustrate an overview diagram of the process of detecting, reporting, and avoiding potholes in a roadway using the vehicle shown in FIG. 1, in accordance with one embodiment of the present disclosure.

FIG. 3 illustrates a timing diagram for the process of detecting, reporting, and avoiding potholes in a roadway using the process shown in FIGS. 2A and 2B and the vehicle shown in FIG. 1.

FIG. 4 illustrates flow chart of an exemplary computer-implemented process of detecting, reporting, and avoiding potholes in a roadway using the vehicle shown in FIG. 1.

FIG. 5 illustrates a simplified block diagram of an exemplary computer system for implementing the processes shown in FIGS. 2-4.

FIG. 6 illustrates an exemplary configuration of a user computer device, in accordance with one embodiment of the present disclosure.

FIG. 7 illustrates an exemplary configuration of a server computer device, in accordance with one embodiment of the present disclosure.

FIG. 8 is a screenshot of one example of a user interface warning the driver of an upcoming pothole using the system shown in FIG. 5.

FIG. 9 is a screenshot of another example of a user interface warning the driver of an upcoming pothole using the system shown in FIG. 5.

FIG. 10 is a screenshot of a further example of a user interface warning the driver of an upcoming pothole using the system shown in FIG. 5.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc — read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The present embodiments may relate to, inter alia, systems and methods for controlling a vehicle for detecting and avoiding road hazards such as potholes. In an exemplary embodiment, the process is performed by a pothole avoidance server in communication with a plurality of vehicle controller computer devices, also known as vehicle controllers.

In the exemplary embodiment, the vehicle includes a plurality of sensors that allow the vehicle to observe its surroundings in real-time. The sensors can include, but are not limited to, radar, LIDAR, proximity sensors, ultrasonic sensors, electromagnetic sensors, wide RADAR, long distance RADAR, Global Positioning System (GPS), video devices, imaging devices, cameras, audio recorders, inertial measurement unit (IMU), and computer vision. The vehicle controller receives information from the sensors. Based on the information from the sensors, the vehicle controller detects that the vehicle just ran over a pothole. The vehicle controller activates a rear-facing camera, such as a back-up camera. The back-up camera takes a video of the pothole that the vehicle ran over. The video and precise location information is transmitted from the vehicle controller to the pothole avoidance server.

The pothole avoidance server identifies a location of the pothole from the video and the precise location information. The pothole avoidance server determines where in the lane that the pothole is and the size of the pothole. The pothole avoidance server stores the information about the pothole.

The pothole avoidance server receives location information from a plurality of vehicle controllers of a plurality of vehicles. The pothole avoidance server compares the location information of the other vehicles to the location of the pothole. If a vehicle is nearing the location of the pothole, the pothole avoidance server notifies the vehicle of the location of the upcoming pothole. As the vehicle nears the pothole, the vehicle controls adjusts the vehicle's position in the lane to avoid the pothole. In the exemplary embodiment, the pothole avoidance server track the location of a plurality of potholes in a plurality of locations and reports those locations to vehicles approaching said locations.

At least one of the technical problems addressed by this system may include: (i) reduced wear on vehicle by avoiding potholes; (ii) improved ride for the driver and passengers; (iii) improved control of the vehicle; and (iv) sharing locations of potholes and/or other objects in the roadway to reduce the chance of damage to multiple vehicles on the roadway.

The methods and systems described herein may be implemented using computer programming or engineering techniques including computer software, firmware, hardware, or any combination or subset thereof, wherein the technical effects may be achieved by performing at least one of the following steps: a) receive a plurality of information from the plurality of sensors; b) detect an obstacle based on the plurality of information from the plurality of sensors, wherein the obstacle is a pothole; c) activate at least one rear-facing sensor of the plurality of sensors to capture a recording of the obstacle, wherein the at least one rear-facing sensor is a back-up camera, and wherein the at least one rear-facing sensor captures at least one of a video and a plurality of images behind the first vehicle including the obstacle; d) transmit the recording of the obstacle and a location of the first vehicle; e) determine a first location of the obstacle based on the recording of the obstacle and the location of the first vehicle; f) store the first location of the obstacle, wherein the remote server stores a plurality of first locations for a plurality of obstacles; g) subsequent to storing the first location of the obstacle, receive a current location of the second vehicle from the second vehicle controller; h) compare the current location of the second vehicle to the stored first location of the obstacle to determine if the second vehicle is approaching the first location; i) if the second vehicle is approaching the first location, transmit information about the obstacle to the second vehicle controller; j) receive the information about the obstacle from the remote server; k) adjust operation of the second vehicle to avoid the obstacle; l) cause the second vehicle to shift to the left or the right to avoid the obstacle; m) shift to the left or the right while staying in the same lane; n) transmit its current location to the remote server periodically; o) compares locations of the plurality of second vehicles to the first location of the obstacle, wherein the remote server is in communication with a plurality of second vehicle controllers each associated with a different second vehicle; p) detect the obstacle based on information from the inertial movement unit, wherein the plurality of sensors include an inertial movement unit; q) detect the obstacle due to vertical movement of the first vehicle due to one or more wheels of the first vehicle impacting the obstacle; and r) display a notification to a driver of the second vehicle, that the second vehicle is adjusting operation to avoid an obstacle.

### Exemplary Vehicle

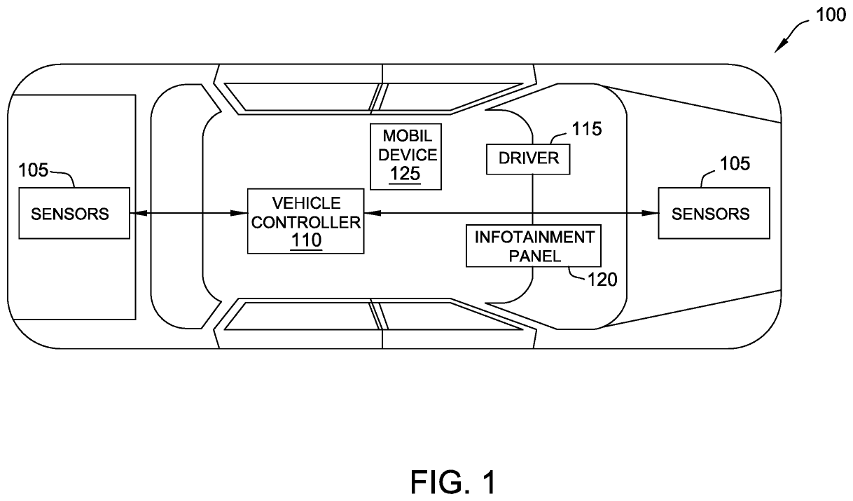

FIG. 1 depicts a view of an exemplary vehicle 100. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and navigating without human input. In other embodiments, vehicle 100 is a manual vehicle or a semi-autonomous vehicle with driver assistance systems, such as, but not limited to, lane keep assistance and parallel parking assistance, where the vehicle may be as a traditional automobile that is controlled by a driver 115.

Vehicle 100 may include a plurality of sensors 105 and a vehicle controller 110. The plurality of sensors 105 may detect the current surroundings and location of vehicle 100. Plurality of sensors 105 may include, but are not limited to, radar, LIDAR, proximity sensors, ultrasonic sensors, electromagnetic sensors, wide RADAR, long distance RADAR, Global Positioning System (GPS), video devices, imaging devices, cameras, audio recorders, inertial measurement unit, and computer vision. Plurality of sensors 105 may also include sensors that detect conditions of vehicle 100, such as speed, acceleration, gear, braking, and other conditions related to the operation of vehicle 100, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 105 may include impact sensors that detect impacts to vehicle 100, including force and direction and sensors that detect actions of vehicle 100, such the deployment of airbags. In some embodiments, plurality of sensors 105 may detect the presence of driver 115 and one or more passengers (not shown) in vehicle 100. In these embodiments, plurality of sensors 105 may detect the presence of fastened seatbelts, the weight in each seat in vehicle 100, heat signatures, or any other method of detecting information about driver 115 and/or passengers in vehicle 100.

In the exemplary embodiment, the plurality of sensors 105 include a back-up camera for viewing behind the vehicle 100. The back-up camera can be used to assist the driver 115 with visibility when backing the vehicle 100 up. The back-up camera can also be used by the vehicle controller 110 while autonomously or semi-autonomously driving the vehicle. In some embodiments, the output of the back-up camera can be displayed in an infotainment panel 120 on the dashboard of the vehicle 100.

In some embodiments, the plurality of sensors 105 may include sensors for determining weight distribution information of vehicle 100. Weight distribution information may include, but is not limited to, the weight and location of remaining gas, luggage, occupants, and/or other components of vehicle 100. In some embodiments, plurality of sensors 105 may include sensors for determining remaining gas, luggage weight, occupant body weight, and/or other weight distribution information.

In one example, plurality of sensors 105 may include LIDAR, radar, weight sensors, accelerometer, gyroscope, compass and/or other types of sensors to identify the orientation and profile of the vehicle 100. Vehicle controller 110 and/or another computing device(s) (e.g., mobile device(s)) may be configured to monitor sensor data from plurality of sensors 105 and/or other sensors to determine weight distribution information and/or location and orientation of the vehicle 100. In one example, vehicle controller 110 may compare sensor data for a particular event (e.g., a road bump) with historical sensor data to identify the weight distribution of vehicle 100 and/or the location of the occupants of vehicle 100. In another example, plurality of sensors 105 may include weight sensors that vehicle controller 110 monitors to determine the weight distribution information.

Vehicle controller 110 may interpret the sensory information to identify appropriate navigation paths, detect threats, and react to conditions. In some embodiments, vehicle controller 110 may be able to communicate with the driver 115 and/or others in the vehicle 100 through the infotainment panel 120 and/or one or more remote computer devices, such as mobile device 125. In the example embodiment, mobile device 125 is associated with driver 115 and includes one or more internal sensors, such as an accelerometer, a gyroscope, and/or a compass. Mobile device 125 may be capable of communicating with vehicle controller 110 wirelessly. In addition, vehicle controller 110 and mobile device 125 may be configured to communicate with computer devices located remotely from vehicle 100.

In some embodiments, vehicle 100 may include autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; (t) autonomous or semi-autonomous lane keeping assistance; and/or other functionality. In these embodiments, the autonomous or semi-autonomous vehicle-related functionality or technology may be controlled, operated, and/or in communication with vehicle controller 110.

The wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; hazard avoidance; navigation or GPS-related systems; security and/or anti-hacking measures; lane keeping assistance; and/or theft prevention systems.

While vehicle 100 may be an automobile in the exemplary embodiment, in other embodiments, vehicle 100 may be, but is not limited to, other types of ground craft, aircraft, watercraft, and spacecraft vehicles.

### Exemplary Process

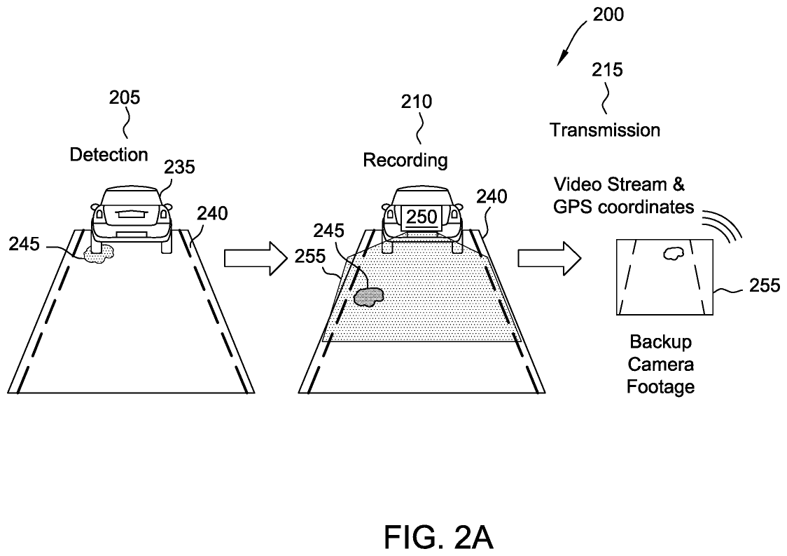

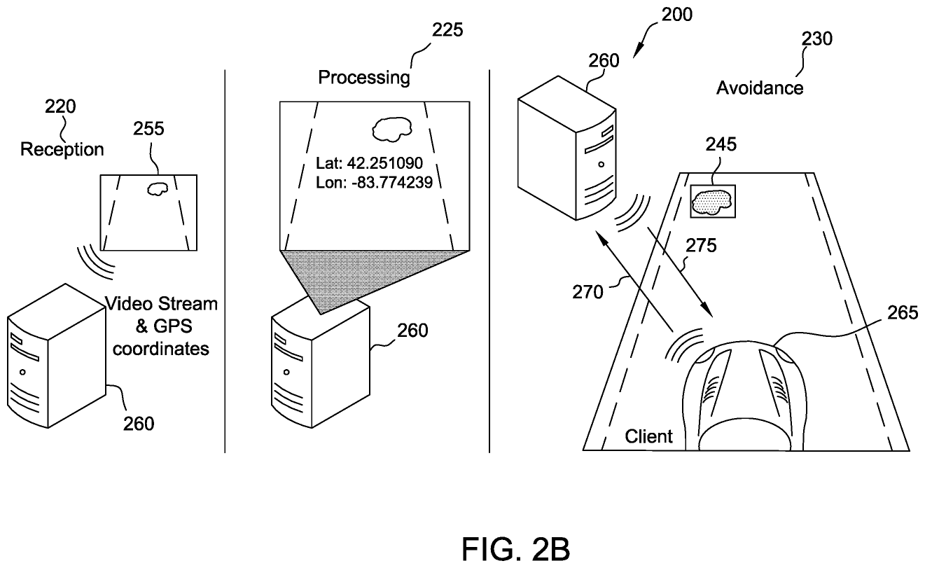

FIGS. 2A and 2B illustrate an overview diagram of the process 200 of detecting, reporting, and avoiding potholes 245 in a roadway 240 using the vehicle 100 (shown in FIG. 1), in accordance with one embodiment of the present disclosure. In the exemplary embodiment, process 200 includes six steps. These steps include Detection 205, Recording 210, Transmission 215, Reception 220, Processing 225, and Avoidance 230.

In the Detection step 205, a first vehicle 235 is driving on a roadway 240 that contains a pothole 245. When the first vehicle 235 runs over the pothole 245, one or more sensors 105 (shown in FIG. 1) detects the impact and vertical movement of the first vehicle 235. In some embodiments, the one or more sensors 105 includes an inertial measurement unit (IMU).

Upon detection of the pothole 245, the first vehicle 235 activates the Recording step 210. In the Recording step 210, the first vehicle 235 activates its rear-facing camera(s) 250, such as the back-up camera 250. The rear-facing camera 250 records 255 the roadway 240 and the pothole 245. In the exemplary embodiment, the rear-facing camera 250 records 255 a video of the roadway 240. In other embodiments, the rear-facing camera 250 records 255 a plurality of images of the roadway 240. Since the first vehicle 235 is traveling away from the pothole 245, the first vehicle 235 has to act quickly to capture the images and/or video of the roadway 240 before the pothole 245 is out of sight, such as, but not limited to, around a curve or under a follow-in vehicle 100.

In the Transmission step 215, the first vehicle 235 packages the recording 255 with GPS coordinates (or other location coordinates) for transmission to an external server. The External server, in this case is the pothole avoidance server 260.

In the Reception step 220, the pothole avoidance server 260 receives the recording 255 of the roadway 240 and the coordinates or other location information of where the recording 255 is from. The location information can include, but is not limited to, roadway name, GPS coordinates, lane, size of lane, direction of travel, vehicle speed, and other information to identify the location of the pothole 245 based on the recording.

In the Processing step 225, the pothole avoidance server 260 analyzes the recording 255 and location information to determine the exact location of the pothole 245. The pothole avoidance server 260 also determines the size and shape of the pothole from the recording 255. Then the pothole avoidance server 260 stores the pothole location and other information for future use. In at least some embodiments, the pothole avoidance server 260 performs image recognition and machine learning to detect the pothole 245 in the recording 255. Furthermore, the pothole avoidance server 260 also determines the exact size and shape of the pothole 245 in addition to the pothole's exact location.

The Avoidance step 230 is constantly occurring. A second vehicle 265 is in communication with the pothole avoidance server 260. The second vehicle 265 provides its current location 270 to the pothole avoidance server 260. The pothole avoidance server 260 compares the current location 270 to the know locations of potholes. If the second vehicle 265 is approaching one of a known locations of a pothole 245, the pothole avoidance server 260 transmits information 275 about that pothole 245 to the second vehicle 265. The information 275 includes, but is not limited to, exact GPS location, lane, size of lane, direction of travel of the roadway 240, the size and shape of the pothole 245, and where in the lane the pothole 245 is. When the second vehicle 265 reaches the location of the pothole 245, the second vehicle 265 may shift its position in the lane to avoid the pothole 245. The goal is for the tires of the second vehicle 265 to not impact the pothole 245. For example, in FIG. 2B, the second vehicle 265 shifts to the right of the lane to avoid the pothole 245. When the second vehicle 265 is past the pothole 245, the second vehicle 265 shifts back to the center of the lane. In this example, the second vehicle 265 may have a lane keeping assistance system (LKAS), where the LKAS knows where the lane is and decides the best way to avoid the pothole 245 while staying in the same lane. This may require the vehicle 265 to approach one or other side of the lane to avoid the pothole 245. The second vehicle 265 may determine to shift to the left or right of the lane and/or to center the vehicle 265 in the lane. The second vehicle 265 may adjust the vehicle 265 to drive to the left or the right of the pothole 245 or to center the vehicle 265 such that the pothole will go under the vehicle 265 with the left and right sets of tires going around the pothole 245. In some embodiments, the second vehicle 265 determines how to avoid the pothole 245. In other embodiments, the information 275 from the pothole avoidance server 260 include instructions or suggestions for how to avoid the pothole 245. After avoiding the pothole 245 the second vehicle 265 will resume its previous position in the lane.

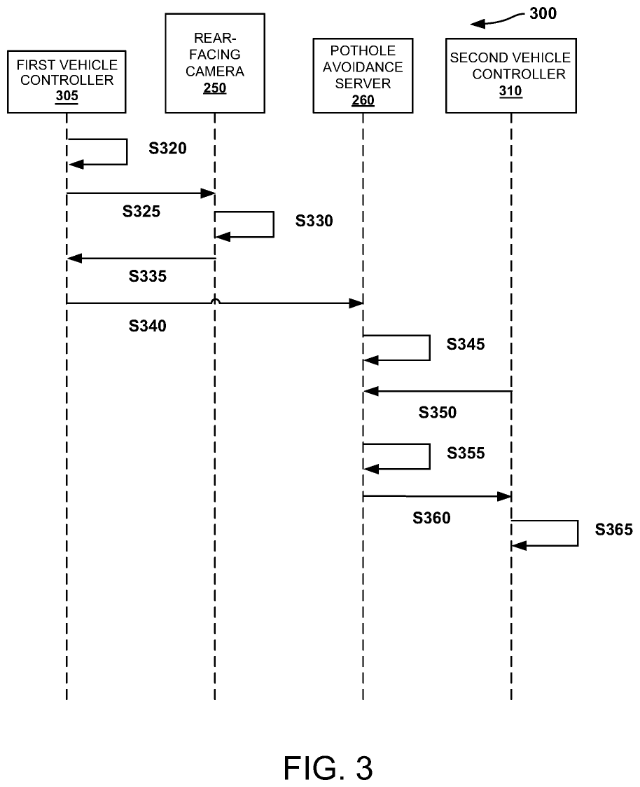

In some further embodiments, the second vehicle controller 310 (shown in FIG. 3) determines how to move the second vehicle 265 to avoid the pothole 245. In these embodiments, the second vehicle controller 310 knows the dimensions of the second vehicle 265 and therefore can calculate/determine the safest and best way to avoid the pothole 245.

In some embodiments, the pothole 245 may take up the entire lane. In these embodiments, the second vehicle controller 310 determines whether or not the second vehicle 265 can shift into an adjacent lane to avoid the pothole 245. The second vehicle controller 310 uses the plurality of sensors 105 to determine if either of the adjacent lanes are clear for the second vehicle 265 to be able to safely shift lanes. In some of these embodiments, the pothole avoidance server 260 knows that to avoid an upcoming pothole 245, the second vehicle 265 has to change lanes. In these embodiments, the pothole avoidance server 260 can inform the second vehicle controller 310 farther in advance to give the second vehicle controller 310 more time to change lanes to avoid the pothole 245.

In situations where the second vehicle 265 in unable to avoid the pothole 245, such as where the pothole 245 covers the entire lane and the second vehicle 265 is unable to change lanes, the second vehicle controller 310 and/or the pothole avoidance server 260 determines the best way for the tires of the second vehicle 265 to impact the pothole 245 to minimize the movement of the second vehicle 265 and/or potential damage to the tires and/or the second vehicle 265.

In still further embodiments, where there are multiple potholes 245 in a roadway 240, the second vehicle controller 310 and/or the pothole avoidance server 260 determines a path or route for the second vehicle 265 to avoid the potholes 245.

### Exemplary Process Timing

FIG. 3 illustrates a timing diagram for the process 300 of detecting, reporting, and avoiding potholes 245 (shown in FIG. 2A) in a roadway 240 (shown in FIG. 2A) using the process 200 (shown in FIGS. 2A and 2B) and the vehicle 100 (shown in FIG. 1). In process 300, the first vehicle 235 (shown in FIG. 2A) includes a first vehicle controller 305 and the rear-facing camera 250, which is one of the plurality of sensors 105 (shown in FIG. 1). The first vehicle controller 305 is also in communication with the pothole avoidance server 260, which, in turn, is in communication with one or more second vehicle controllers 310 in one or more corresponding second vehicles 265 (shown in FIG. 2B).

In step S320, the first vehicle controller 305 detects a pothole 245. In at least some embodiments, the first vehicle controller 305 receives information from one or more sensors 105 and detects that the first vehicle 235 has run over a pothole 245. In at least one example, the first vehicle controller 305 detects vertical movement as the first vehicle 235 impacts with the pothole 245.

In step S325, the first vehicle controller 305 activates the rear-facing camera 250. In step S330, the rear-facing camera 250 activates and records the roadway 240 behind the first vehicle 235 including the pothole 245. In step S335, the rear-facing camera 250 transmits the recording to the first vehicle controller 305. In step S340, the first vehicle controller 305 transmits the recording to the pothole avoidance server 260. In the exemplary embodiment, the first vehicle controller 305 also transmits precise location information about the first vehicle 235 to the pothole avoidance server 260.

In step S345, the pothole avoidance server 260 analyzes the recording and the precise location information to determine the exact position of the pothole 245. The pothole avoidance server 260 also stores the information about the pothole 245. In at least some embodiments, the pothole avoidance server 260 performs image recognition and machine learning to detect the pothole 245 in the recording 255. Furthermore, the pothole avoidance server 260 also determines the exact size and shape of the pothole 245 in addition to the pothole's exact location. If the pothole avoidance server 260 already has information about the pothole 245, the pothole avoidance server 260 may analyzes the new information to determine if there are any changes to the pothole 245. For example, the pothole 245 may have changed in size and/or shape since the last time that that pothole 245 was analyzed by the pothole avoidance server 260. In at least one embodiment, the first vehicle 235 may have been attempting to avoid the pothole 245, but the change in shape and/or size caused the first vehicle 235 to impact the pothole 245 and thus trigger process 300.

In step S350, the pothole avoidance server 260 receives location information from the second vehicle controller 310 of the second vehicle 265. In step S355, the pothole avoidance server 260 compares the location information from the second vehicle controller 310 to that of the known locations of potholes 245. If the second vehicle 265 is approaching a known pothole 245, the pothole avoidance server 260 transmits S360 the information about the pothole 245. Then in step S365, the second vehicle controller 310 controls the second vehicle 265 to avoid the pothole 245.

In the exemplary embodiment, steps S350 through S365 are repeated on a regular basis for a plurality of vehicles 100 traveling on roadways 240. For example, each vehicle 100 may continually check with the pothole avoidance server 260 to see if there are any upcoming potholes on its lane in the roadway 240.

While the above processes 200 and 300 are described with regards to potholes 245, these processes can also be used for other obstructions on the roadway 240, such as, but not limited to, animals, recent repairs, vehicle litter, aka tire treads, fallen trees and/or branches, or any other obstruction on the roadway 240. Furthermore, these processes may also be used for other types of vehicles, such as, but not limited to, watercraft, where the watercraft is avoiding obstacles, aka submerged branches, sandbars, and other obstructions that may cause damage to or interfere with the operation of vehicles.

### Exemplary Computer Process

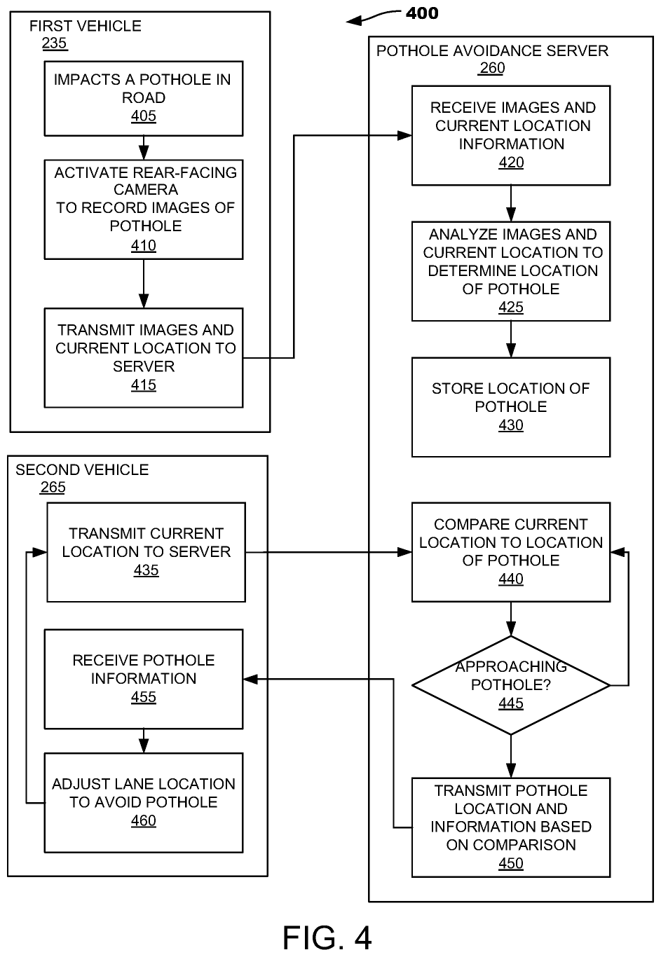

FIG. 4 illustrates flow chart of an exemplary computer-implemented process 400 of detecting, reporting, and avoiding potholes 245 (shown in FIG. 2A) in a roadway 240 (shown in FIG. 2A) using the vehicle 100 (shown in FIG. 1).

In process 400, the first vehicle 235 impacts 405 a pothole 245 in the roadway 240. The first vehicle controller 305 (shown in FIG. 30 detects the pothole 245 due to inputs of one or more sensors 105 (shown in FIG. 1) in the first vehicle 235. For example, the inertial measurement unit may detect the impact. The first vehicle controller 305 activates 410 the rear-facing camera 250 (shown in FIG. 2A) to record images of the pothole 245. These images may be a video or a collection of images at different points in time. The first vehicle controller 305 transmits 415 the images and location information to the pothole avoidance server 260. The location information can include, but is not limited to, roadway name, GPS coordinates, lane, size of lane, direction of travel, vehicle speed, and other information to identify the location of the pothole 245 based on the images.

The pothole avoidance server 260 receives 420 the images and the location information. The pothole avoidance server 260 analyzes 425 the images and the location information to determine the exact location of the pothole 245. Once the location of the pothole 245 has been determined, the pothole avoidance server 260 stores 430 the location and other information about the pothole 245 for further use.

In some embodiments, there are multiple pothole avoidance servers 260 for different geographic areas or other delineations. In these embodiments, the vehicle 100 is in communication with the appropriate pothole avoidance server 260. These servers 260 may work in concordance to ensure that the proper information is provided to vehicles 100 as the information is needed based on the vehicle's location.

In the exemplary embodiment, a plurality of second vehicles 265 are traveling along different roadways 240. Each of the plurality of second vehicles 265 transmit 435 their current location information to the pothole avoidance server 260 via their corresponding second vehicle controller 310. The pothole avoidance server 260 compares 440 the current location of the corresponding second vehicle 265 to determines 445 if the corresponding second vehicle 265 is approaching a pothole 245. The pothole avoidance server 260 may make the determination 445 based on, but not limited to, the speed of the vehicle 265, the current GPS location of the vehicle 265, the current lane of the vehicle 265, the direction of travel of the vehicle 265, and/or other factors.

For example, if the second vehicle 265 is in the far right lane and a pothole 245 is in the far left lane, the pothole avoidance server 260 might determine that the second vehicle 265 is not approaching that pothole 245. In other embodiments, if the pothole 245 is one lane over from the vehicle 265, the pothole avoidance server 260 may provide the pothole information in case the driver 115 changes lanes. In some embodiments, the second vehicle 265 transmits 435 the location information on a regular basis, and the pothole avoidance server 260 determines 445 whether the second vehicle 265 will approach the pothole 245 based on the speed of the vehicle 265 and the amount of distance that the vehicle 265 will cover until it next transmits 435 location information.

If the vehicle 265 is not approaching a pothole 245, then the pothole avoidance server 260 takes no further action. If the vehicle is approaching a pothole 245, then the pothole avoidance server 260, transmits 450 pothole location and avoidance information to the second vehicle controller 310.

The second vehicle controller 310 receives 455 the pothole information. The second vehicle controller 310 controls the second vehicle 265 to adjust 460 the vehicle's lane location to avoid the pothole 245.

### Exemplary Computer System

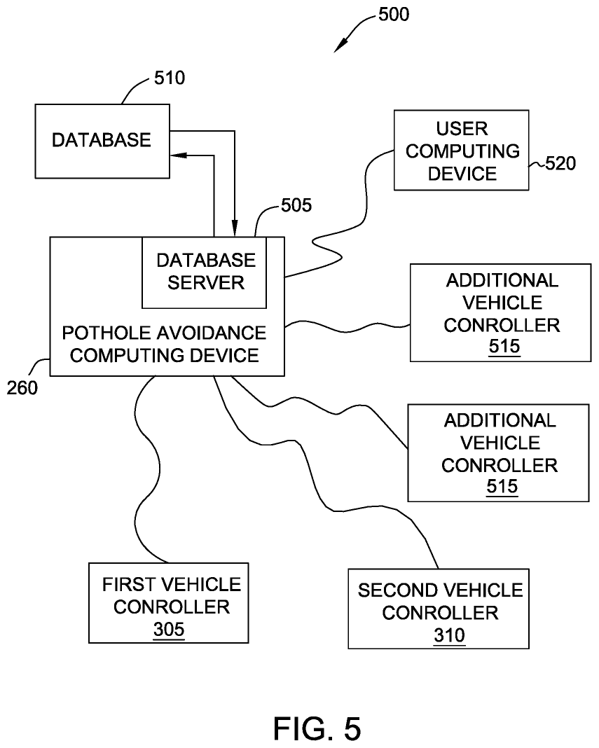

FIG. 5 illustrates a simplified block diagram of an exemplary computer system 500 for implementing the processes 200, 300, and 400 (shown in FIGS. 2-4). In the exemplary embodiment, computer system 500 may be used for monitoring vehicles 100 (shown in FIG. 1) for detecting potholes 245 (shown in FIG. 2A) and for reporting the location of potholes to vehicles 100. As described below in more detail, a pothole avoidance server 260 (also known as a pothole avoidance computer device 260) may be configured to (i) receive a recording 255 (shown in FIG. 2A) and location information of an obstacle 245 from the first vehicle controller 305, where the recording 255 includes at least one of video or a plurality of images of the obstacle 245 in a roadway 240 (shown in FIG. 2A); (ii) determine a first location of the obstacle 245 based on the recording 255 of the obstacle 245 and the location of the first vehicle 235 (shown in FIG. 2A); (iii) store the first location of the obstacle 245; (iv) subsequent to storing the first location of the obstacle 245, receive a current location of the second vehicle 265 (shown in FIG. 2B) from the second vehicle controller 310; (v) compare the current location of the second vehicle 265 to the stored first location of the obstacle 245 to determine if the second vehicle 265 is approaching the first location; and (vi) if the second vehicle 265 is approaching the first location, transmit information about the obstacle 245 to the second vehicle controller 310, where the second vehicle controller 310 is programmed to adjust operation of the second vehicle 265 to avoid the obstacle 245.

In the exemplary embodiment, first vehicle controller 305, second vehicle controller 310, and additional vehicle controllers 515 are computers that control one or more aspects of the operation of a vehicle 100 and are similar to vehicle controller 110 (both shown in FIG. 1). Furthermore, first vehicle controller 305, second vehicle controller 310, and additional vehicle controllers 515 are in communication with one or more pothole avoidance servers 260, using the Internet or other network. More specifically, first vehicle controller 305, second vehicle controller 310, and additional vehicle controllers 515 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

A database server 505 may be communicatively coupled to a database 510 that stores data. In one embodiment, database 510 may include pothole information including location and size information, vehicle information, and travel information such as road speeds. In the exemplary embodiment, database 510 may be stored remotely from pothole avoidance computer device 260. In some embodiments, database 510 may be decentralized. In the exemplary embodiment, the user may access database 510 via user computer device 520 by logging onto pothole avoidance computer device 260, as described herein.

In the exemplary embodiment, user computer devices 520 are computers that include a web browser or a software application, which enables user computer devices 520 to access remote computer devices, such as pothole avoidance computer device 260, using the Internet or other network. More specifically, user computer devices 520 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 520 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

Pothole avoidance computer device 260 may be communicatively coupled with one or more of first vehicle controller 305, second vehicle controller 310, and additional vehicle controllers 515. In some embodiments, pothole avoidance computer device 260 may be associated with, or is part of a computer network associated with a vehicle manufacturer or a travel information provider, or in communication with vehicle manufacturing network or travel information provider network. In other embodiments, pothole avoidance computer device 260 may be associated with a third party and is merely in communication with the vehicle manufacturing or travel information providing networks. More specifically, pothole avoidance computer device 260 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Pothole avoidance computer device 260 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, pothole avoidance computer device 260 hosts an application or website that allows the first vehicle controller 305, second vehicle controller 310, and additional vehicle controllers 515 to access the functionality described herein. In some further embodiments, first vehicle controller 305, second vehicle controller 310, and additional vehicle controllers 515 include an application that facilitates communication with pothole avoidance computer device 260.

### Exemplary Client Device

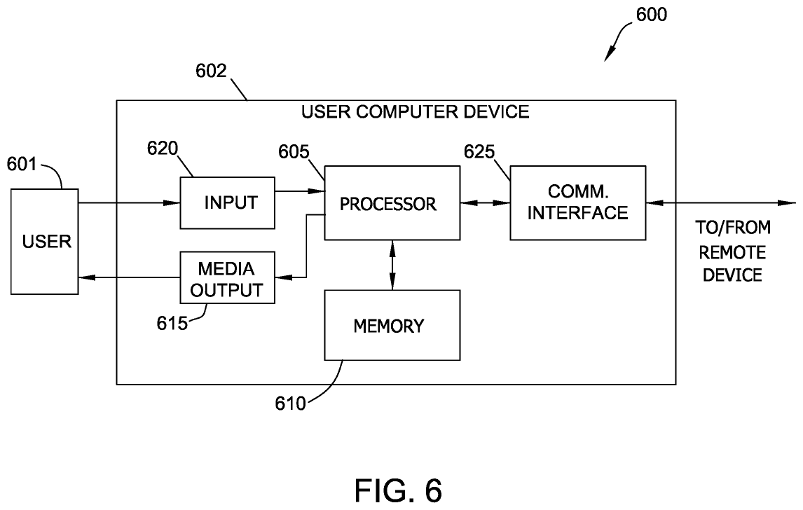

FIG. 6 depicts an exemplary configuration 600 of user computer device 602, in accordance with one embodiment of the present disclosure. In the exemplary embodiment, user computer device 602 may be similar to, or the same as, and user computer device 520 (shown in FIG. 5). User computer device 602 may be operated by a user 601. User computer device 602 may include, but is not limited to, vehicle controller 110 (shown in FIG. 1), first vehicle controller 305, second vehicle controller 310 (both shown in FIG. 3), additional vehicle controllers 515 (shown in FIG. 5), and user computer device 520. User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or repair data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing pothole information. In some embodiments, user computer device 602 may include an input device 620 for receiving input from user 601. User 601 may use input device 620 to, without limitation, acknowledge receiving pothole information.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as pothole avoidance computer device 260 (shown in FIG. 2B). Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from pothole avoidance computer device 260. A client application may allow user 601 to interact with, for example, pothole avoidance computer device 260. For example, instructions may be stored by a cloud service, and the output of the execution of the instructions sent to the media output component 615.

In some embodiments, user computer device 602 may include, or be in communication with, one or more sensors, such as sensor 105 (shown in FIG. 1). User computer device 602 may be configured to receive data from the one or more sensors and store the received data in memory area 610. Furthermore, user computer device 602 may be configured to transmit the sensor data to a remote computer device, such as vehicle controller 110 or pothole avoidance server 260, through communication interface 625.

The types of autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; (t) autonomous or semi-autonomous lane keeping assistance; and/or other functionality.

In the exemplary embodiment, the vehicle 100 includes a plurality of sensors 105 (shown in FIG. 1) and a vehicle controller 110. The vehicle controller includes at least one processor 605 in communication with at least one memory device 610. The vehicle controller 110 collects a plurality of sensor information observed by the plurality of sensors 105 during operation of the vehicle 100. The vehicle controller 110 analyzes the plurality of sensor information to detect a pothole 245 (shown in FIG. 2A) and to record images and/or video of the pothole 245. The vehicle controller 110 transmits the images and/or video and location information to the pothole avoidance server 260. In addition, the vehicle controller 110 controls the vehicle 100 to travel avoid or over other potholes 245 that have been previously detected, where the information has been provided by the pothole avoidance server 260.

### Exemplary Server Device

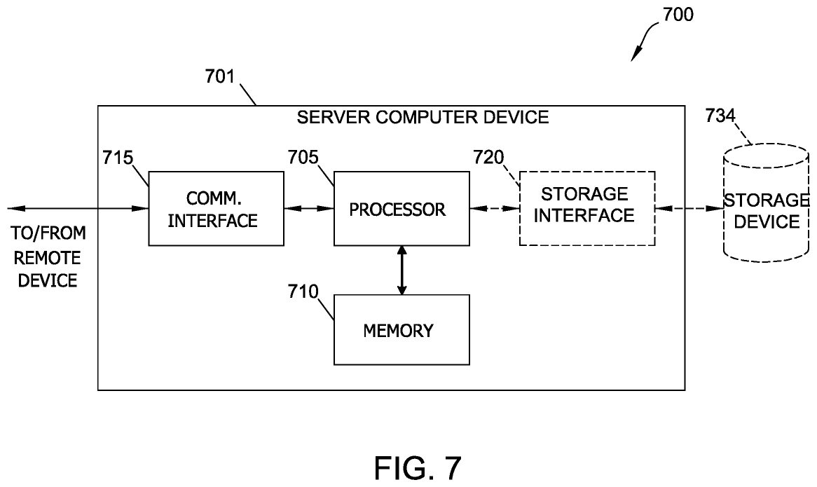

FIG. 7 depicts an exemplary configuration 700 of a server computer device 701, in accordance with one embodiment of the present disclosure. In the exemplary embodiment, server computer device 701 may be similar to, or the same as, pothole avoidance computer device 260 (shown in FIG. 2B). Server computer device 701 may include, but is not limited to, pothole avoidance computer device 260 and database server 505 (shown in FIG. 5). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, pothole avoidance computer device 260, first vehicle controller 305, second vehicle controller 310 (both shown in FIG. 3), additional vehicle controllers 515, and user computer devices 520 (both shown in FIG. 5) (for example, using wireless communication or data transmission over one or more radio links or digital communication channels). For example, communication interface 715 may receive requests from user computer devices 520 via the Internet, as illustrated in FIG. 5.

Processor 705 may also be operatively coupled to a storage device 734. Storage device 734 may be any computer-operated hardware suitable for storing and/or retrieving data, such as, but not limited to, data associated with database 510 (shown in FIG. 5). In some embodiments, storage device 734 may be integrated in server computer device 701. For example, server computer device 701 may include one or more hard disk drives as storage device 734.

In other embodiments, storage device 734 may be external to server computer device 701 and may be accessed by a plurality of server computer devices 701. For example, storage device 734 may include a storage area network (SAN), a network attached storage (NAS) system, and/or multiple storage units such as hard disks and/or solid state disks in a redundant array of inexpensive disks (RAID) configuration.

In some embodiments, processor 705 may be operatively coupled to storage device 734 via a storage interface 720. Storage interface 720 may be any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 2-4.

### Exemplary User Interface

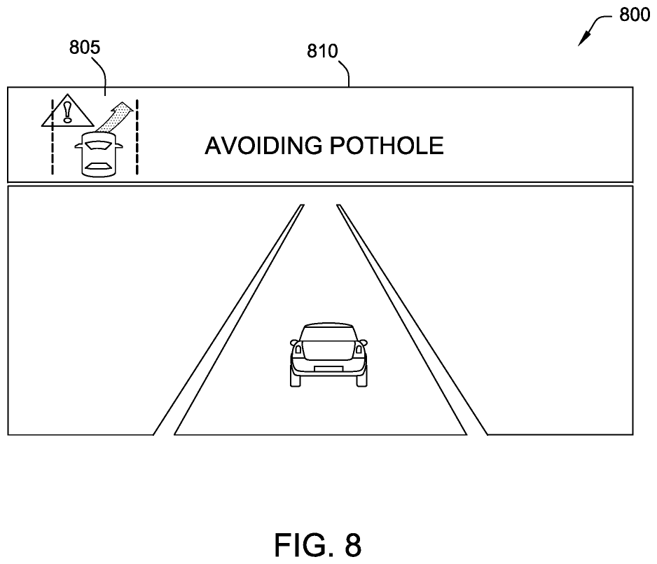

FIG. 8 is a screenshot of one example of a user interface 800 warning the driver 115 (shown in FIG. 1) of an upcoming pothole 245 (shown in FIG. 2A) using the system 500 (shown in FIG. 5). In the exemplary embodiment, the user interface warning is to give the driver 115 advance warning that the vehicle 100 (shown in FIG. 1) will be shifting to avoid an obstacle, such as a pothole 245, so that the driver 115 understands that the vehicle 100 will moving and thus will not fight against the movement.

In FIG. 8, the user interface 800 displays an indicator arrow 805 showing the direction that the vehicle 100 will be moving to avoid the pothole 245. The user interface 800 also displays a text indicator 810 explaining why the vehicle 100 will be shifting or moving in the lane. In the exemplary embodiment, user interface 800 is displayed by the infotainment panel 120 (shown in FIG. 1). In other embodiments, the user interface 800 may be displayed on the dashboard, such as through indicator lights or on a heads-up display on the windshield.

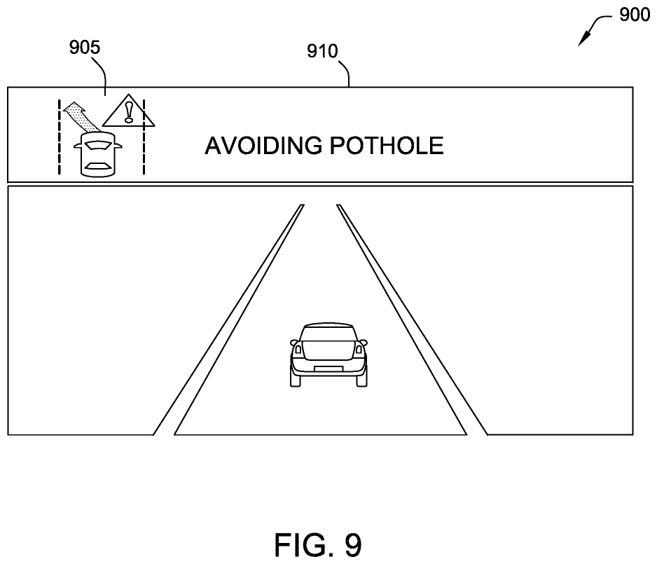

FIG. 9 is a screenshot of another example of a user interface 900 warning the driver 115 (shown in FIG. 1) of an upcoming pothole 245 (shown in FIG. 2A) using the system 500 (shown in FIG. 5). In FIG. 9, the user interface 900 displays an indicator arrow 905 showing the direction that the vehicle 100 (shown in FIG. 1) will be moving to avoid the pothole 245. The user interface 900 also displays a text indicator 910 explaining why the vehicle 100 will be shifting or moving in the lane. In the exemplary embodiment, user interface 900 is displayed by the infotainment panel 120 (shown in FIG. 1). In other embodiments, the user interface 900 may be displayed on the dashboard, such as through indicator lights or on a heads-up display on the windshield.

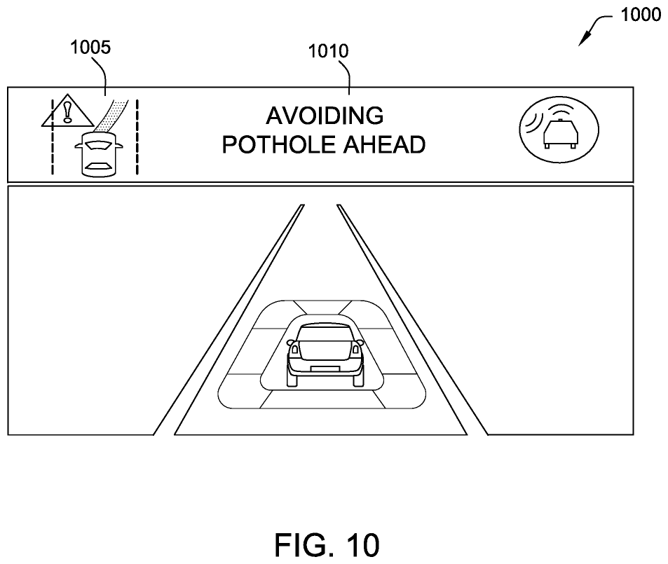

FIG. 10 is a screenshot of a further example of a user interface 1000 warning the driver 115 (shown in FIG. 1) of an upcoming pothole 245 (shown in FIG. 2A) using the system 500 (shown in FIG. 5). In FIG. 10, the user interface 1000 displays an indicator arrow 1005 showing the direction that the vehicle 100 (shown in FIG. 1) will be moving to avoid the pothole 245. The user interface 1000 also displays a text indicator 1010 explaining why the vehicle 100 will be shifting or moving in the lane. In the exemplary embodiment, user interface 1000 is displayed by the infotainment panel 120 (shown in FIG. 1). In other embodiments, the user interface 1000 may be displayed on the dashboard, such as through indicator lights or on a heads-up display on the windshield.

### Machine Learning & Other Matters

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on mobile computing devices, or associated with smart infrastructure or remote servers), and/or via computer executable instructions stored on non-transitory computer-readable media or medium.

In some embodiments, a care coordination support platform computing device is configured to implement machine learning, such that the pothole avoidance computing device “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to: user data, caregiver data, sensor data, assignment data, calendar data, task data, recording data, location data, and/or alert data. ML outputs may include but are not limited to: user data, caregiver data, calendar data, task data, identification data, location data, and/or assignment data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. For example, a ML module may receive training data comprising image data, sensor data, and location data, caregiver data, and assignment data associated with pothole data. The ML module may then generate a model which maps image data to aspects of the pothole data. The ML module may then generate assignment data as a ML output based upon subsequently received image data and location data.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above. For example, a ML module may receive unlabeled data comprising image data, sensor data, and location data. The ML module may employ an unsupervised learning method such as “clustering” to identify patterns and organize the unlabeled data into meaningful groups. The newly organized data may be used, for example, to generate a model which associates image data and location data.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

The reward signal definition may be based upon any of the data inputs or ML outputs described above. For example, a ML module may implement reinforcement learning in identifying and reporting potholes. The ML module may utilize a decision-making model to generate location data for potholes based upon image data, and may further receive user-satisfaction data indicating a level of satisfaction experienced by a user and a vehicle which avoided a known pothole (e.g., the second vehicle successfully avoided the pothole based on sensor data from the second vehicle). A reward signal may be generated by comparing the user-satisfaction data to an assignment score based on the successful avoidance of the pothole.

Based upon the reward signal, the ML module may update the decision-making model such that subsequently generated assignment scores more accurately predict pothole locations. For example, the ML module may determine that a pothole in a specific portion of the roadway is better to avoid by going over rather than shifting to the left or the right. The user may enjoy the smoother ride and report that satisfaction. Therefore, the user and the vehicle may both rate the “transaction” highly. Accordingly, the ML module may learn to automatically direct vehicles in different manners based on the position, size, and shape of the detected potholes.

### Additional Considerations

For the methods discussed directly above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; lane keeping assistance; and/or theft prevention systems.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., pothole location information, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the safety of operation of autonomous and semi-autonomous vehicles by reducing the potential for damage to the vehicles and the vehicle's surroundings.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for securely navigating around obstacles, such as potholes, are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. 1 A system comprising:
a first vehicle including a plurality of sensors and a first vehicle controller;
a remote server including at least one processor and at least one memory device; and
a second vehicle including a second vehicle controller,
wherein the first vehicle controller is programmed to:
receive a plurality of information from the plurality of sensors;
detect an obstacle based on the plurality of information from the plurality of sensors;
activate at least one rear-facing sensor of the plurality of sensors to capture a recording of the obstacle; and
transmit the recording of the obstacle and a location of the first vehicle,
wherein the remote server is programmed to:
determine a first location of the obstacle based on the recording of the obstacle and the location of the first vehicle;
store the first location of the obstacle;
subsequent to storing the first location of the obstacle, receive a current location of the second vehicle from the second vehicle controller;
compare the current location of the second vehicle to the stored first location of the obstacle to determine if the second vehicle is approaching the first location; and
if the second vehicle is approaching the first location, transmit information about the obstacle to the second vehicle controller, and
wherein the second vehicle controller is programmed to:
receive the information about the obstacle from the remote server;
adjust operation of the second vehicle to avoid the obstacle.

2. The system of claim 1, wherein to adjust the operation of the second vehicle to avoid the obstacle, the second vehicle controller is programmed to cause the second vehicle to shift to the left or the right to avoid the obstacle.

3. The system of claim 2, wherein the second vehicle is controlled to shift to the left or the right while staying in the same lane.

4. The system of claim 1, wherein the obstacle is a pothole.

5. The system of claim 1, wherein the second vehicle controller is further programmed to transmit its current location to the remote server periodically.

6. The system of claim 1, wherein the remote server is in communication with a plurality of second vehicle controllers each associated with a different second vehicle.

7. The system of claim 6, wherein the remote server compares locations of the plurality of second vehicles to the first location of the obstacle.

8. The system of claim 1, wherein the remote server stores a plurality of first locations for a plurality of obstacles.

9. The system of claim 1, wherein the at least one rear-facing sensor is a back-up camera.

10. The system of claim 1, wherein the at least one rear-facing sensor captures at least one of a video and a plurality of images behind the first vehicle including the obstacle.

11. The system of claim 1, wherein the plurality of sensors include an inertial movement unit, and wherein the first vehicle controller is further programmed to detect the obstacle based on information from the inertial movement unit.

12. The system of claim 1, wherein the first vehicle controller detects the obstacle due to vertical movement of the first vehicle due to one or more wheels of the first vehicle impacting the obstacle.

13. The system of claim 1, wherein the second vehicle controller is further programmed to display a notification to a driver of the second vehicle, that the second vehicle is adjusting operation to avoid an obstacle.

14. A computer device comprising at least one processor and at least one memory device, wherein the computer device is in communication with a first vehicle controller associated with a first vehicle and further in communication with a second vehicle controller associated with a second vehicle, wherein the at least one processor is programmed to:
receive a recording and location information of an obstacle from the first vehicle controller, wherein the recording includes at least one of video or a plurality of images of the obstacle in a roadway;
determine a first location of the obstacle based on the recording of the obstacle and the location of the first vehicle;
store the first location of the obstacle;
subsequent to storing the first location of the obstacle, receive a current location of the second vehicle from the second vehicle controller;
compare the current location of the second vehicle to the stored first location of the obstacle to determine if the second vehicle is approaching the first location; and
if the second vehicle is approaching the first location, transmit information about the obstacle to the second vehicle controller, wherein the second vehicle controller is programmed to adjust operation of the second vehicle to avoid the obstacle.

15. The computer device of claim 14, wherein the recording was captured by at least one rear-facing sensor of the first vehicle.

16. The computer device of claim 14, wherein to adjust the operation of the second vehicle to avoid the obstacle, the second vehicle controller is programmed to cause the second vehicle to shift to the left or the right to avoid the obstacle.

17. The computer device of claim 14, wherein the at least one processor is further programmed to receive the current location of the second vehicle periodically.

18. The computer device of claim 14, wherein the at least one processor is further programmed to receive the current location of a plurality of second vehicles from a plurality of second vehicle controllers each associated with a different second vehicle of the plurality of second vehicles.

19. The computer device of claim 18, wherein the at least one processor is further programmed to compare the current locations of the plurality of second vehicles to the first location of the obstacle.

20. The computer device of claim 14, wherein the at least one processor is further programmed to store a plurality of first locations for a plurality of obstacles.
